(19) United States
(12) Patent Application Publication
(10) Pub. No.: US 2004/0006721 A1
(43) Pub. Date: Jan. 8, 2004

(54) Method and apparatus for responding to a thermal throttling signal

(76) Inventors: Robin Laurie Getz, Sherwood, OR (US); David Edward Hanrahan, San Jose, CA (US)

Correspondence Address: MARGER JOHNSON & MCCOLLOM PC, 1030 SW MORRISON STREET, PORTLAND, OR, 97205, US

(21) Appl. No.: 10/366,726

(22) Filed: Feb. 14, 2003

Related U.S. Application Data
(60) Provisional application No. 60/358,777, filed on Feb. 22, 2002.

(51) Int. Cl. G06F 1/20

(52) U.S. Cl. 713/600

(57) ABSTRACT

A method and apparatus is disclosed for responding to a thermal throttling signal from an electronic device.

### CROSS REFERENCE TO RELATED APPLICATIONS

This application claims the benefit of priority under 35 USC §119(e) to U.S. Provisional Application No. 60/358,777, filed on Feb. 22, 2002, the contents of which are hereby incorporated by reference in their entirety for all purposes. This application is also related to co-pending U.S. Non-Provisional Application No. ______, filed on Feb. 14, 2003, entitled METHOD FOR AUTOMATIC THERMAL CALIBRATION OF A COOLING SYSTEM, by the same inventors as the present application, and whose contents are hereby incorporated by reference in their entirety for all purposes.

### BACKGROUND OF THE INVENTION

1. Technical Field of the Invention Embodiments of the invention relate in general to temperature control systems, and in particular to a method and apparatus for responding to a thermal throttling signal to improve system performance.

2. Description of the Related Art

Many new high performance devices, such as the Intel Pentium 4 processor, can modulate their internal clock for processor reliability concerns. For example, in addition to an on-chip thermal diode, Intel's Pentium 4 processor has a dedicated on-chip thermal management mechanism called the Thermal Monitor. The Thermal Monitor consists of a fast-acting circuit called the Thermal Control Circuit (TCC). The TCC modulates the CPU's clock frequency at a pre-programmed temperature to maintain the processor's die temperature within factory specifications. This internal clock modulation is also known as thermal throttling. Thermal throttling limits the amount of heat generated by slowing down the clock speed of processor or by temporarily stopping the processor clocks altogether. In addition to the internal circuitry, an external pin signals when the TCC becomes active, or when the processor is running beyond the maximum case temperature. In the Intel Pentium™ 4 processor, the name of this pin is PROCHOT.

As explained above, the TCC is pre-set in the factory to maintain the processor's die temperature. In practice, however, there are a number of things beyond the control of the systems board designer which can cause the TCC to activate and PROCHOT to be asserted. These include, but are not limited to, improper mounting of the processor's heatsink, an under-rated heatsink, too much thermal grease, insufficient thermal grease, fan failures, inadequate airflow through the system chassis, and too many high power peripherals for the fans to adequately cool.

FIG. 1 is a digital oscilloscope screen capture showing the thermal throttling assertions from an Intel Pentium 4 processor whose case temperature exceeded its maximum specifications as per the appropriate Pentium™ 4 datasheet. The TCC only activates for very brief periods, e.g. 1 ms. The PROCHOT output is low (asserted) for this TCC activation time, and during this period (thermal throttling mode), the processor's clock speed is reduced to 1 GHz. When the pin PROCHOT is high (not asserted), the processor runs at the normal speed of 2 GHz. If the Thermal Specifications for the processor continue to be exceeded, the TCC will activate more frequently.

The thermal throttling circuit on the Pentium™ 4 processor asserts in the following manner: (1) Temperature of the thermal throttling circuit reaches some critical value, and thermal throttling begins. (2) Thermal throttling lasts for a fixed time set by a counter in the processor. This is dependent on the clock speed of the processor. (3) The thermal throttling causes the temperature to decrease. (4) When the counters expire, thermal throttling ceases and the processor returns to full speed. (5) Because the processor is again running at full speed, the temperature increases. Thermal throttling restarts as soon as the temperature increases to the critical value, and the process is repeated.

FIG. 2A is a graph of the cumulative PROCHOT assertions occurring in one second versus time measured in seconds (with maximum case temperature exceeded). As shown in FIG. 2A, the longer the processor's maximum case temperature is exceeded, the more frequently PROCHOT assertions occur and the greater the performance reduction.

FIG. 2B is a graph of the processor speed in GHz vs. time showing how thermal throttling influences the speed of the Pentium™ 4 processor when the die temperature reaches the critical value. At 600 seconds on the time axis, the maximum processor case temperature is exceeded, the TCC becomes active, and PROCHOT is asserted low. As the die temperature continues to increase, the thermal throttling occurs more frequently, until throttling is eventually on 100% of the time. In FIG. 2B, this occurs 5 minutes later at 900 seconds on the time axis. If thermal throttling assertions are happening at a faster and faster rate, the performance of the system increasingly suffers as well.

Although thermal throttling can prevent catastrophic failure of the processor, it adversely affects system performance. In other words, if thermal throttling assertions are occurring at an increased rate, system performance is also being impacted more frequently because the processor is in the slower thermal throttling mode for a higher proportion of the time. In this situation, appropriate corrective actions should be taken such as adjusting the fan speed or changing the computational load. In a well-designed system it should be expected that thermal throttling is only activated periodically and for very brief amounts of time. So merely detecting thermal throttling assertions, by itself, is not very useful. Thermal throttling assertions may only assert a couple of times a day, or may never assert if the processor is running a minimal load.

Presently there is no method or device that monitors the thermal throttling assertions in an effective manner or that informs system management software that a substantial reduction in system performance due to thermal throttling is present so that appropriate, optimized corrective actions may be taken.

### BRIEF DESCRIPTION OF THE DRAWINGS

FIG. 1 is a digital oscilloscope screen capture of the thermal throttling assertions from an Intel Pentium™ 4 processor.

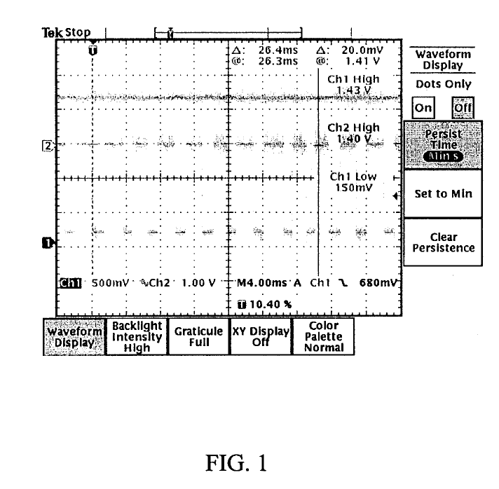

FIG. 2A is a graph of the cumulative PROCHOT assertions occurring in one second versus time measured in seconds.

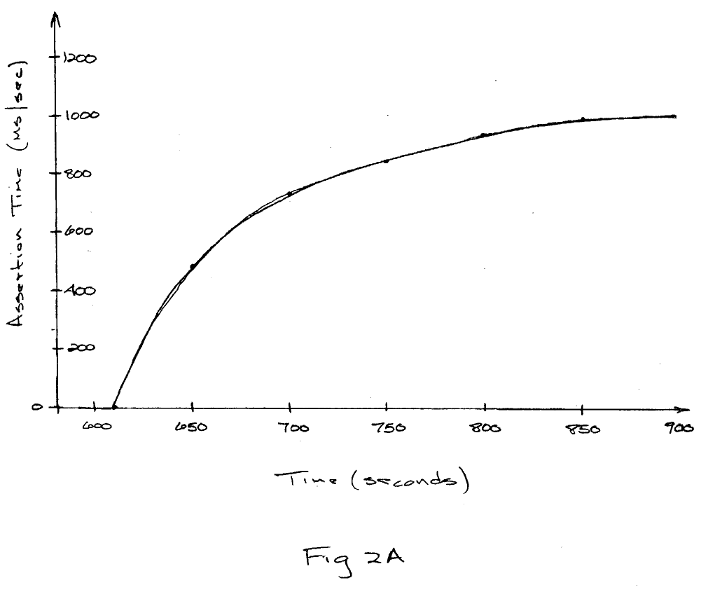

FIG. 2B is a graph of processor speed vs. time showing how thermal throttling influences the speed of the Pentium™ 4 processor when the die temperature reaches the critical value.

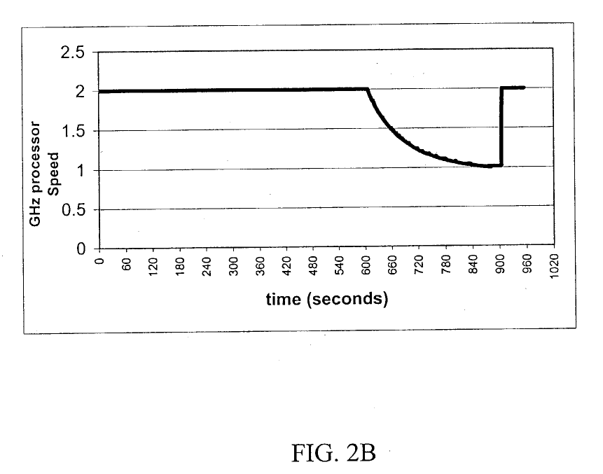

FIG. 3 is a 24-pin ASIC in accordance with an embodiment of the invention.

FIGS. 4A, 4B, and 4C are diagrams illustrating how thermal throttling assertions are measured according to an embodiment of the invention with an 8-bit register.

FIG. 5 is a diagram illustrating how system interrupts are generated from the cumulative thermal throttling assertion time with the 8-bit register of FIGS. 4A-4C.

### DETAILED DESCRIPTION OF THE INVENTION

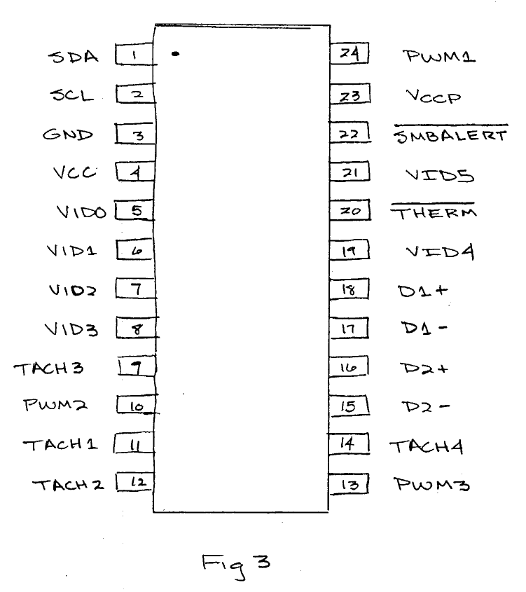

FIG. 3 is an illustration of the pinouts for a 24-pin ASIC embodiment of the present invention. Pin 1 (SDA) is for SMBus bidirectional serial data. Pin 2 (SCL) is for SMBus serial clock input. Pin 3 (GND) is the ground pin. Pin 4 (Vcc) is the power supply pin, which in this embodiment can be +5 V or +3.3 V. Pins 5-8 (VID0-VID3) are digital inputs for voltage supply readouts from the CPU. Pin 9 (TACH3) is a fan tachometer input for measuring the speed of a third attached fan (not shown). Pin 10 (PWM2) is a pulse width modulated output to control a second attached fan (not shown). Pins 11 and 12 (TACH1 and TACH2) are fan tachometer inputs for measuring the speed of a first attached fan (not shown) and the second attached fan.

Pin 13 (PWM3) is a pulse width modulated output to control the third attached fan. Pin 14 (TACH4) is a fan tachometer input for measuring the speed of a fourth attached fan (not shown). Pin 15 (D2−) is the cathode connection for temperature measurement of a second thermal diode (not shown). Pin 16 (D2+) is the anode connection for temperature measurement of the second thermal diode. Pin 17 (D1−) is the cathode connection for temperature measurement of a first thermal diode (not shown). Pin 18 (D1+) is the anode connection for temperature measurement of the first thermal diode. Pin 19 (VID4) is a fourth digital input for a voltage-supply readout from the CPU.

Pin 21 (VID5) is a fifth digital input for a voltage supply readout from the CPU. Pin 23 (Vccp) is an analog input that monitors the processor core voltage. Pin 24 (PWM1) is for digital pulse width modulated output for speed control of the first attached fan.

The two pins of particular importance in this disclosure are pin 20 and pin 22, the thermal throttling input pin THERM and the interrupt output pin SMBALERT, respectively. Pin 20, THERM, is a bidirectional pin. As will be explained in further detail below, THERM is connected to a thermal throttling signal to time and monitor thermal throttling assertions. THERM may also be used as an output to signal over-temperature conditions or for clock modulation purposes. Pin 22, SMBALERT, is a digital output that is used to signal thermal limit conditions.

In other embodiments of the invention, there may be a different number of pins associated with the ASIC package or the pins may be reconfigurable to perform different functions. In other words, the number of pins or the physical layout of the pins is not limiting in any way. Furthermore, the invention is not strictly limited only to ASIC packages as illustrated in FIG. 3.

The thermal throttling signal used as input for the THERM input pin may be from any device that outputs an external thermal throttling signal. These devices include, but are not limited to, processors, graphics chipsets, and field-programmable gate arrays. Because the PROCHOT thermal throttling signal from Intel's Pentium™ 4 processor has already been used as an example in the description of the related art, it will continued to be used as an exemplary thermal throttling signal in the following discussion, recognizing that doing so does not limit the invention in any way.

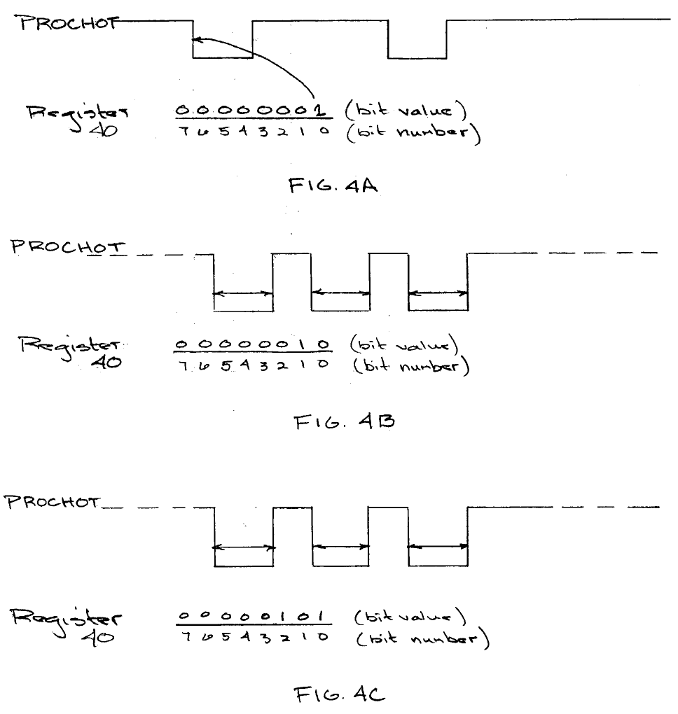

FIGS. 4A, 4B, and 4C are diagrams illustrating how thermal throttling assertion times are measured according to the embodiment of the invention illustrated in FIG. 3. The embodiment of FIG. 3 has an 8-bit internal timer to measure the cumulative time that the PROCHOT thermal throttling signal is asserted. The timer is started on the assertion (PROCHOT low) of the embodiment's THERM pin by the PROCHOT thermal throttling signal, and is stopped on the negation (PROCHOT high) of the THERM pin. The timer counts the thermal throttling assertion times cumulatively, i.e. the timer resumes counting on the next PROCHOT assertion. The PROCHOT timer will continue to accumulate PROCHOT assertion times until the timer is read by system software (the timer is cleared upon read) or until the timer reaches full scale.

Referring to FIG. 4A, the 8-bit PROCHOT timer register 40 is designed such that bit zero is set to 1 when the first PROCHOT assertion (PROCHOT low) is detected. According to this embodiment, once the cumulative PROCHOT assertion time has exceeded 45.52 ms (FIG. 4B), bit one of the PROCHOT timer is set to 1, and bit zero is cleared, becoming the least significant bit of the timer with a resolution of 22.76 ms. That is, the timer register is incremented by one every time the cumulative PROCHOT exceeds a multiple of 22.76 ms. For example, in FIG. 4C, the PROCHOT register indicates that PROCHOT thermal throttling signal has been asserted for at least [(1×2²)+(0×2¹)+(1×2⁰)]×[22.76 ms]=113.8 ms.

In this embodiment, it was explained how the cumulative PROCHOT assertion times were measured using the PROCHOT timer register 40. Other embodiments of the invention may instead be configured to track the cumulative time between adjacent PROCHOT assertions.

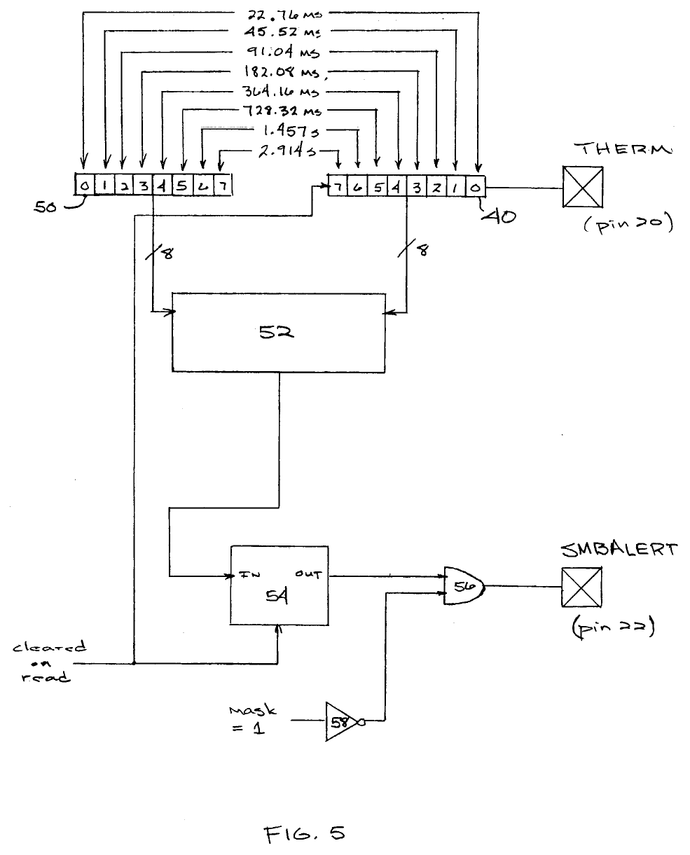

FIG. 5 is a functional block diagram illustrating the monitoring circuitry of the embodiment of FIG. 3. The monitoring circuitry generates system interrupts using the cumulative thermal throttling assertion time from the 8-bit PROCHOT register of FIGS. 4A4C. The embodiment of the invention can generate system interrupts when a programmable limit has been exceeded. This allows the systems designer to ignore brief, infrequent thermal throttling assertions while capturing longer thermal throttling events that could signify a more serious thermal problem within the system.

Referring to FIG. 5, register 40 is the 8-bit PROCHOT timer register of FIGS. 4A-4C. Register 50 is an 8-bit PROCHOT limit register. FIG. 5 also indicates the length of time that the bits in registers 40 and 50 represent. Measured from the time that the first PROCHOT assertion occurs, register 50 allows a limit from 0 seconds to 5.825 seconds to be set by the user, which becomes the value that must be exceeded before a system interrupt is generated on the SMBALERT pin (SMBALERT high). The value in PROCHOT timer register 40 and the value in the PROCHOT limit register 50 are compared by comparator 52. If the value in register 40 exceeds the value in register 50, a status bit from an interrupt status register (not shown) is set to 1 by latch 54, and this serves as one input to AND gate 56. The other input to AND gate 56 is taken from inverter 58. The input for inverter 58 is a mask bit from a mask register (not shown). When the mask bit is set to 1, the output from AND gate 56 is 0 regardless of the state of the status bit from the interrupt status register. If, on the other hand, the mask bit set to 0 the output of AND gate 56 is 1 and the SMBALERT pin is asserted (SMBALERT high).

The PROCHOT timer register 40 is reset every time system software reads the timer. In this embodiment the frequency at which the timer is read is once every minute, but alternate embodiments may be read more or less frequently depending on system requirements. After the PROCHOT timer register 40 is read, the contents of register 40 are cleared-on-read. Assuming that the PROCHOT limit has been exceeded, the status bit from the interrupt status register is cleared as well by resetting latch 54. If the PROCHOT timer register 40 is read at the same time a PROCHOT assertion is occurring, the contents of register 40 are cleared and bit zero of register 40 is set to 1 (since a thermal throttling assertion is occurring). At that point, the PROCHOT timer register 40 is incremented from zero. In this embodiment, pre-programming a value of 0×00 to the PROCHOT limit register 50 results in a system interrupt SMBALERT at the first PROCHOT assertion. Preprogramming a value of 0×01 to the PROCHOT limit register 50 generates an SMBALERT once cumulative PROCHOT assertions exceed 45.52 ms.

Thus, this embodiment of the invention monitors an external thermal throttling signal from a processor, graphics chipsets, FPGA (field programmable gate array), or other device in order to determine relative system performance. This embodiment of the invention detects whenever the throttling signal is asserted and measures the cumulative time duration that the throttling signal has been asserted for. This embodiment of the invention has a programmable thermal throttling limit that is set to ignore short thermal throttling assertions but reports longer thermal throttling assertions, which could signal a more serious thermal problem within the system. This allows a mechanism for determining the severity of the thermal event.

In accordance with another embodiment of the invention, when a thermal throttling signal is asserted, a timer is started. The timer keeps a cumulative reading of the number of thermal throttling assertions. The system software periodically reads the timer and uses the number to calculate how often the processor, high performance chip, or other device is in thermal throttling mode.

Alternatively, when a thermal throttling signal is asserted, still another embodiment of the invention may start or stop a plurality of timers. For example, one timer keeps track of the elapsed time between assertions, and a second timer keeps track of the times when assertions were made. These values are then used by the monitoring device to output another value so that system software can determine the percentage of time that the system is in thermal throttling mode.

According to yet another embodiment of the invention, a timer is reset every time that a thermal throttling assertion occurs, and the monitoring device outputs a signal to the system software when the time between thermal throttling assertions is less than a pre-selected value.

Embodiments of the invention may predict what the performance impact will be and take corrective action. In some cases, corrective action would entail speeding up cooling fans, removing computational load, or simply reporting to the end user. For example, in the embodiment of the invention illustrated in FIG. 3, the embodiment also has the ability to monitor the fan speed of up to four attached fans through the digital inputs TACH1-TACH4 (pins 11, 12, 9, and 14, respectively) and control the speed of those fans through the pulse-width modulated outputs PWM1-PWM3 (pins 24, 10, and 13, respectively), where two of the fans are connected in parallel and thus controlled by the same pulse-width modulated output.

Having described and illustrated the principles of the invention, it should be apparent that the invention can be modified in arrangement and detail without departing from such principles. Accordingly, such changes and modifications are considered to fall within the scope of the following claims.

1. A method for responding to a thermal throttling signal from an electronic device comprising keeping a cumulative record of thermal throttling assertions.

2. A method according to claim 1 wherein keeping a cumulative record of thermal throttling assertions comprises starting a timer when the thermal throttling signal is asserted.

3. A method according to claim 2 further comprising clearing the timer when the timer is read.

4. A method according to claim 1 further comprising reporting the cumulative record to a user.

5. A method for responding to a thermal throttling signal from an electronic device comprising keeping track of the time between assertions of the thermal throttling signal.

6. A method for responding to a thermal throttling signal from an electronic device comprising keeping track of the time durations of assertions of the thermal throttling signal.

7. A method for responding to a thermal throttling signal from an electronic device comprising:
using a first timer to record time between assertions of the thermal throttling signal; and
using a second timer to record the time duration of an assertion of the thermal throttling signal.

8. A method according to claim 7 further comprising dividing the time duration of assertions by the time between assertions.

9. A method for responding to a thermal throttling signal from an electronic device comprising:
monitoring successive time durations between assertions of the thermal throttling signal; and
comparing successive time durations between assertions of the thermal throttling signal.

10. A method according to claim 9 further comprising taking action if the successive time durations between assertions of the thermal throttling signal changes.

11. An apparatus for responding to a thermal throttling signal from an electronic device comprising a monitoring device coupled to the electronic device and constructed and arranged to keep a cumulative record of assertions of the thermal throttling signal.
